(19) United States
(12) Patent Application Publication
(10) Pub. No.: US 2013/0090770 A1
(43) Pub. Date: Apr. 11, 2013

(54) SYSTEM AND METHOD FOR AUTOMATICALLY CONTROLLING ENERGY APPARATUS USING ENERGY MODELING TECHNIQUE

(71) Applicants: CHU YONG LEE, SEOUL (KR); HEUNG SOO PARK, NAMYANGJU-SI (KR)

(72) Inventors: CHU YONG LEE, SEOUL (KR); HEUNG SOO PARK, NAMYANGJU-SI (KR)

(73) Assignees: HANWHA SOLUTION & CONSULTING CO., LTD., SEOUL (KR); EZVILLE CO., LTD., SEOUL (KR)

(21) Appl. No.: 13/288,894

(22) Filed: Nov. 3, 2011

(30) Foreign Application Priority Data
Oct. 7, 2011 (KR) 10-2011-0102398

(51) Int. Cl. G06F 1/28; G05D 23/19

(52) U.S. Cl. 700/277

(57) ABSTRACT

A system and method for automatically controlling an energy apparatus using an energy modeling technique is disclosed. The energy management service system for managing the use of energy of each region may include an energy collecting unit to collect energy usage information of an energy apparatus consuming energy in a region through a remote metering server, an apparatus collecting unit to collect control state information of the energy apparatus through a home network device installed in the region to control the operation of the energy apparatus, and an energy management unit to determine an energy usage control factor based on the energy usage trend and to automatically control the operation of the energy apparatus based on the energy usage control factor.

### CROSS-REFERENCE TO RELATED APPLICATION

This application claims the priority benefit of Korean Patent Application No. 10-2011-0102398, filed on Oct. 7, 2011, in the Korean Intellectual Property Office, the disclosure of which is incorporated herein by reference.

### BACKGROUND

1. Field of the Invention

Exemplary embodiments of the present invention relate to a system and method for automatically controlling an energy apparatus, using an energy modeling technique to minimize wasting of energy and improve energy efficiency.

2. Description of the Related Art

Recently with the rise of climate change and energy problems as global concerns, issues such as power consumption and carbon emission are being raised as key issues in many fields.

Conventional energy consumption patterns are such that energy consumption and billing are made based on an initial contact between users and suppliers without a special control or management function. As a result, the balance between supply and demand of energy is difficult, and in particular, systematic energy consumption is impossible for users. Accordingly, countries short on resources have many tribulations in formulating an energy management policy.

Recently, in an effort to solve the problems involving the supply and demand of energy, suggestions have been made for efficient consumption of limited energy, such as time zone-based differential billing, real-time billing, and the like. Conventionally, however, an electricity meter, a water meter, or a gas meter installed for energy demand measurement and energy management, and an operating and management server of suppliers supplying electricity, water, or gas mainly use an algorithm developed for the purpose of load management and billing

Also, a conventional energy management system used in an apartment, a house or a building operates to automatically control an energy apparatus related to temperature, lighting, ventilation, cooling/heating, or hot water, when an amount of energy used by the energy apparatus reaches a target amount set arbitrarily by a user to control the energy apparatus. Korean Patent No. 10-1029300, registered Apr. 7, 2011, discloses an integrated energy management system in which energy consumed across a city is integratedly managed using IP-Ubiquitous Sensor Networks (IP-USN)-based energy information collecting sensors and power line communication (PLC) communication-based electric power apparatuses that are installed in houses, buildings, and city facilities.

However, because this conventional energy management system controls an energy apparatus based only on a value set by a user, there is a limitation in improving the energy efficiency.

In the present specification, a solution is suggested for managing energy consumption more efficiently by adaptively dealing with a change in the surrounding environment, such as an absence of residents, weather, seasonal variations, temperature/humidity, and the like, when controlling an energy apparatus.

### SUMMARY

An aspect of the present invention provides an energy management service system and method that may automatically control an energy apparatus using an energy modeling technique to minimize wasting of energy and improve energy efficiency.

Another aspect of the present invention also provides an energy management service system and method that may manage energy consumption more efficiently by adaptively coping with a change in the surrounding environment, such as an absence of residents, weather, seasonal variations, temperature/humidity, and the like, when controlling an energy apparatus.

Another aspect of the present invention also provides an energy management service system and method that may adaptively control an energy apparatus depending on a situation by combining energy apparatus usage information and environment information through energy modeling.

According to an aspect of the present invention, there is provided an energy management service system for managing energy usage for each region, including an energy collecting unit to collect energy usage information of an energy apparatus consuming energy in a region through a remote metering server, a temperature/humidity collecting unit to collect temperature/humidity information including temperature and humidity of the region through a temperature sensor and a humidity sensor installed in the region, a resident collecting unit to collect resident information including at least one of an entry of residents residing in the region and a number of residents, through at least one sensor of a motion sensor and a magnetic sensor installed in the region, an apparatus collecting unit to collect control state information of the energy apparatus through a home network device installed in the region to control an operation of the energy apparatus, an environment collecting unit to collect external environment information including weather and seasonal variations from a web based server through a linkage to the web based server, an energy modeling unit to model an energy usage trend of the region using the energy usage information, the temperature/humidity information, the resident information, the control state information, and the external environment information, and an energy management unit to determine an energy usage control factor for the region based on the energy usage trend and to automatically control the operation of the energy apparatus in the region based on the energy usage control factor.

In an aspect of the present invention, the energy modeling unit may accumulate the energy usage information and the control state information for each predetermined period, may analyze an actual energy usage trend of the region, and may model an energy usage trend exhibiting improved energy efficiency when compared to a predetermined percentage relative to the temperature/humidity information, the resident information, and the external environment information.

In another aspect of the present invention, the energy management unit may determine at least one of lighting, internal temperature, ventilation, and cutting of standby power, to be the energy usage control factor.

In another aspect of the present invention, the energy management unit may transmit the energy usage control factor to a home network device, and the home network device may then generate a control signal for the energy apparatus based on the energy usage control factor and may control the operation of the energy apparatus based on the control signal.

In another aspect of the present invention, the energy management unit may transmit the energy usage trend and the energy usage control factor to the home network device to display the energy usage trend and the energy usage control factor via a display means equipped to the home network device, and when a resident requests an automatic control through the home network device, may automatically control the energy apparatus based on the energy usage factor.

According to another aspect of the present invention, there is provided an energy management service method in an energy management service system for managing the energy usage for each region, including collecting energy usage information of an energy apparatus consuming energy in a region through a remote metering server, collecting temperature/humidity information including temperature and humidity of the region through a temperature sensor and a humidity sensor installed in the region, collecting resident information including at least one of the entrance of residents residing in the region and the number of residents through at least one sensor of a motion sensor and a magnetic sensor installed in the region, collecting control state information of the energy apparatus through a home network device installed in the region to control the operation of the energy apparatus, collecting external environment information including weather and seasonal variations from a web based server through a link to the based web server, modeling an energy usage trend of the region using the energy usage information, the temperature/humidity information, the resident information, the control state information and the external environment information, and determining an energy usage control factor of the region based on the energy usage trend and automatically controlling the operation of the energy apparatus in the region based on the energy usage control factor.

### Effect of the Invention

The exemplary embodiments of the present invention may automatically control an energy apparatus using an energy modeling technique to minimize wasting of energy and improve energy efficiency.

The exemplary embodiments of the present invention may manage energy more efficiently by adaptively controlling energy depending on a change in the surrounding environment such as an absence of residents, weather, seasonal variations, and temperature/humidity.

The exemplary embodiments of the present invention may collect and organize usage information of an energy apparatus used in an apartment, a house or a building and environment information, and may determine an optimum energy efficiency through energy modeling. Accordingly, the exemplary embodiments of the present invention may efficiently manage energy consumption by automatically controlling the energy apparatus using a determined value to obtain the optimum energy efficiency.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an entire configuration of an energy management service system using an energy modeling technique according to an embodiment of the present invention;

FIG. 2 is a block diagram illustrating an internal configuration of an energy management service system for adaptively controlling energy usage depending on a change in a surrounding environment through energy modeling according to an embodiment of the present invention; and

FIG. 3 is a flowchart illustrating an energy management service method for adaptively controlling energy usage depending on a change in a surrounding environment through energy modeling according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Exemplary embodiments of the present invention may be applied to an integrated energy management system that may monitor and control an amount of electricity, gas, or water consumed in each house or city facility, based on a power line communication (PLC) communication technique, in which a power line installed to supply electricity to each house or city facility is used as a communication line, and based on a wireless communication means such as internet protocol-ubiquitous sensor network (IP-USN), Wi-Fi, RF, and the like.

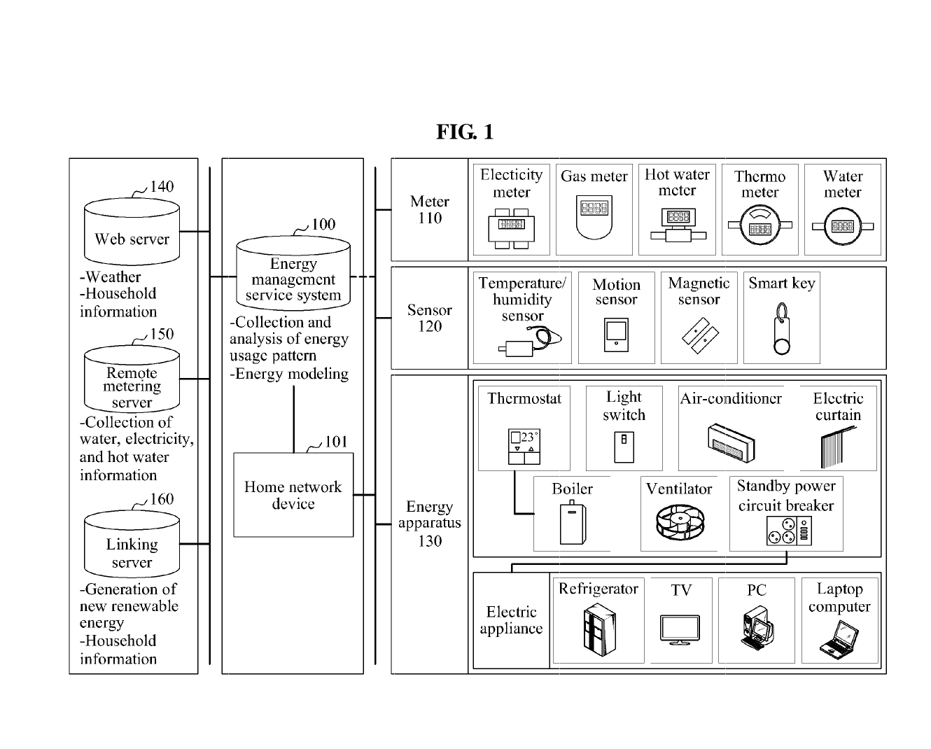

FIG. 1 is a diagram illustrating an entire configuration of an energy management service system using an energy modeling technique according to an embodiment of the present invention. In FIG. 1, an energy management service system 100 for adaptively managing energy depending on the situation by combining energy apparatus usage information and various forms of environment information is shown.

The energy management service system 100 may have a central energy control over an apartment, or a house composed of a plurality of households (hereinafter referred to as “regions”) to prevent wasting of energy in each region and ensure energy saving.

For this purpose, the energy management service system 100 may be linked to a home network device 101 over the entire region (region 1 to region ‘m’) based on serial communication. In this instance, the energy management service system 100 may communicate with a meter 110, a sensor 120, and an energy apparatus 130 that are installed in a region, through the home network device 101 according to the RS485 communication standard. The RS485 communication standard is an expanded version of RS232 and RS422 communication standards, and defines a standard protocol in serial communication that supports a home network. The RS485 communication standard adopts the RS422 communication mode to make up for the drawbacks of the RS232 mode having a low transmission rate and a short transmission range, and enables data transmission between all devices in the same line, but not data transmission between master and slave devices.

The home network device 101 may basically consist of a display means and a controller, and may be configured as a home network wall-pad attached on the wall of a predetermined location within a region. Here, the home network wall-pad may be basically in the type of touch screen to provide an interface with a resident residing in a house. The home network wall-pad may provide a door phone function, and various functions including video phone, Internet access, and TV receiving, as well as crime prevention, disaster prevention, and control of an energy apparatus. In other words, the home network device 101 may have a central control over the energy apparatus 130 in a region by maintaining a connection with the energy apparatus 130 through a wired/wireless communication interface. When the home network device 101 receives a request by the energy management service system 100, the home network device 101 may collect control state information of the energy apparatus 130 and may transmit the information to the energy management service system 100. In this instance, the control state information may be an energy usage specification for each energy apparatus, such as a power on/off time or an on/off state. Also, when the home network device 101 receives a request from the energy management service system 100, the home network device 101 may provide the energy management service system 100 with temperature/humidity information of a region sensed by the sensor 120 installed in the region, particularly, a temperature sensor and a humidity sensor.

The meter 110 linked to the home network device 101 may include an electricity meter, a gas meter, a hot water meter, a thermometer, and a water meter. The sensor 120 may include at least one sensor of a motion sensor, a magnetic sensor and a smart key for sensing at least one resident information of the entrance of residents and the number of residents, a temperature sensor for sensing the temperature of a region, and a humidity sensor for sensing the humidity of a region. The energy apparatus 130 may include a standby power circuit breaker for an electric appliance (for example, a refrigerator, a TV, a personal computer (PC), and a laptop computer), a boiler, a thermostat, a light switch, an air-conditioner, an electric curtain, and a ventilator. Here, the energy apparatus 130 may cover all apparatuses or equipment consuming energy from sources such as electricity, gas, water, and the like, that are installed or provided in a cooling/heating device, an electric appliance, a lighting device, and the like.

Further, the energy management service system 100 may be linked to an external server such as a transmission control protocol/internet protocol (TCP/IP) network-based web server 140, a remote metering server 150, and a linking server 160.

The web server 140 may serve as a database that stores and maintains external environment information including weather and seasonal variations for each region. Also, the web server 140 may collect resident information (or household information) sensed by the sensor 120 installed in a region, and may serve as a database that stores and maintains the collected resident information. In response to a request by the energy management service system 100, the web server 140 may provide the energy management service system 100 with external environment information including weather and seasonal variations of an area corresponding to a region and resident information within a region.

The remote metering server 150 linked to the home network device 101 of each region may collect and organize energy usage information including at least one of an electricity usage amount, a gas usage amount, a water usage amount, and a hot water usage amount from the meter 110 of a corresponding region. The remote metering server 150 may collect energy usage information through the meter 110 installed in a region, and in response to a request by the energy management service system 100, may provide the energy management service system 100 with the collected energy usage information.

The linking server 160 may build a database that provides separate energy information related to generation of new renewable energy or charging of electric vehicles.

The energy management service system 100 of the foregoing structure may collect, for each region, energy usage information, temperature/humidity information, resident information, control state information of the energy apparatus 130, and external environment information, and may adaptively manage energy depending on the situation through energy modeling, based on the information.

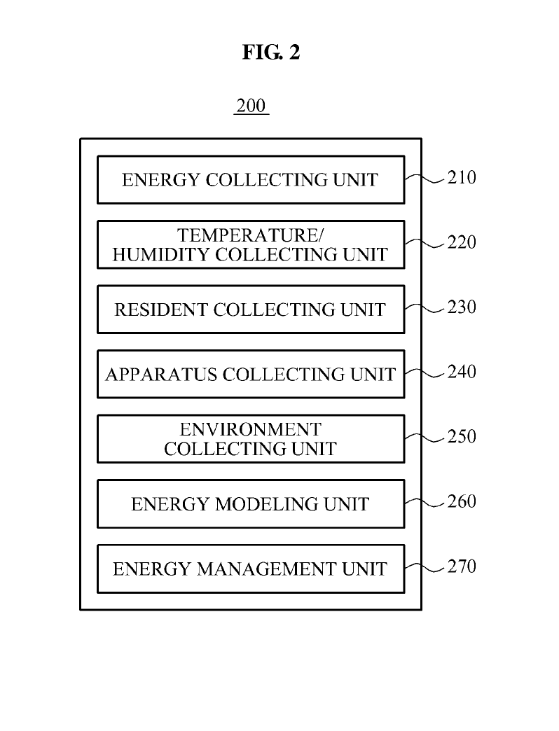

The configuration and function of an energy management service system 200 according to an embodiment of the present invention is described in detail with reference to FIG. 2.

FIG. 2 is a block diagram illustrating an internal configuration of an energy management service system for adaptively controlling the use of energy depending on a change in the surrounding environment through energy modeling according to an embodiment of the present invention. As shown in FIG. 2, an energy management service system 200 according to an embodiment of the present invention may include an energy collecting unit 210, a temperature/humidity collecting unit 220, a resident collecting unit 230, an apparatus collecting unit 240, an environment collecting unit 250, an energy modeling unit 260, and an energy management unit 270.

The energy collecting unit 210 may collect, for each region, energy usage information of an energy apparatus in a corresponding region through a remote metering server. Here, the energy usage information may include at least one of an electricity usage amount, a gas usage amount, a water (water/sewage) usage amount, and a hot water usage amount. The remote metering server may periodically collect energy usage information through a meter installed in a region, and may transmit the collected information to the energy collecting unit 210. Then, the energy collecting unit 210 may collect energy usage information from the remote metering server in the unit of one period of minute, hour, day, week, and month, and may organize the information.

The temperature/humidity collecting unit 220 may collect temperature/humidity information including temperature and humidity of a corresponding region through a temperature sensor and a humidity sensor installed in the region. In other words, the temperature/humidity collecting unit 220 may monitor temperature/humidity information with a temperature sensor and a humidity sensor in a region, and may organize and store the monitored information in the system in real time or per predetermined period unit (for example, 5 minutes, 30 minutes, 1 hour, and the like).

The resident collecting unit 230 may collect resident information including entry of at least one of residents residing in a region and a number of residents. The resident collecting unit 230 may monitor entry of people within a region by means of a motion sensor, a magnetic sensor, or a smart key installed in the region, and may provide the energy management service system 200 with presence/absence information. Accordingly, the resident collecting unit 230 may collect information about entry of residents and the number of residents through a sensor.

The apparatus collecting unit 240 may collect control state information of an energy apparatus through a home network device installed in a region to control the operation of the energy apparatus. The home network device may monitor the control state of a temperature controller, a light switch, an air-conditioner, a ventilator, a standby power circuit breaker, and an electric curtain, over which the home network device has control, and may provide the control state information to the energy management service system 200. Accordingly, the apparatus collecting unit 240 may collect control state information of the energy apparatus through the home network device in the region.

The environment collecting unit 250 may collect external environment information including temperature and seasonal variations of an area corresponding to a region from a web server through a linkage to the web server. In other words, the web server may collect and organize weather and seasonal variations for each region, and may provide weather and seasonal variations of a corresponding region in response to a request by the environment collecting unit 250 constituting the energy management service system 200.

The energy modeling unit 260 may model, for each region, an energy usage trend of a region using information collected by the energy collecting unit 210, the temperature/humidity collecting unit, the resident collecting unit 230, the apparatus collecting unit 240, and the environment collecting unit 250, that is, energy usage information, temperature/humidity information, resident information, control state information of an energy apparatus, and external environment information. For example, the energy modeling unit 260 may accumulate energy usage information and control state information of an energy apparatus per predetermined period, may analyze an actual energy usage trend of a region, and may model an energy usage trend for energy saving based on temperature/humidity information, resident information, and external environment information, to improve energy efficiency more than a predetermined percentage relative to the actual energy usage trend. Also, the energy modeling unit 260 may collect the modeled information and may analyze an energy usage pattern for energy efficiency improvement. In other words, to improve the energy efficiency more than a predetermined percentage relative to an actual energy usage trend, the energy modeling unit 260 may determine an energy usage pattern suitable for the current situation (that is, temperature/humidity information, resident information, and external environment information). For example, because an amount of electricity used increases during summer when compared the amount of electricity used in other seasons, due to use of an air-conditioner, and an amount of energy consumed for producing hot water or heating increases during winter when compared to an amount energy consumed for other purposes, the energy modeling unit 260 may model an energy usage trend in consideration of different energy usage patterns for each season. Also, because an energy usage pattern for two residents is different from an energy usage pattern for four residents, the energy modeling unit 260 may use resident information in modeling an energy usage trend.

The energy management unit 270 may determine an energy usage control factor for a corresponding region based the modeled energy usage trend, and may automatically control the operation of an energy apparatus in the region based on the determined energy usage control factor. In this instance, the energy management unit 270 may determine, as the energy usage control factor, at least one of lighting, internal temperature, ventilation, and cutting of standby power, for the purpose of energy saving of the region. For example, when analysis shows that an actual electricity usage trend is relatively high, even though the number of residents is two, the energy management unit 270 may determine an energy usage control factor by lowering the lighting of a corresponding region or by cutting the standby power of some energy apparatus. Also, when the internal temperature of a corresponding region is maintained to be excessively high, the energy management unit 270 may determine an energy usage control factor by lowering the internal temperature by about 1 to 2 degrees through a thermostat in consideration of weather.

The energy management unit 270 may transmit the determined energy usage control factor to a home network device of a corresponding region, and the home network device may then generate a control signal for an energy apparatus of the corresponding region based on the energy usage control factor and may control the operation of the energy apparatus based on the generated control signal. Furthermore, the energy management unit 270 may be linked to a display means installed in a region to monitor at least one resident residing in the region, so that the energy management unit 270 may display the energy usage trend and the energy usage control factor of the region via the display means. In this instance, the display means may include a wall-pad as a display equipped in the home network device, and a communication terminal such as a smart phone, a tablet, a PC, and the like, as well. Also, the energy management unit 270 may display the energy usage trend and the energy usage control factor of the region on a web page through web access. In other words, the energy management unit 270 may enable a resident to check the determined energy usage control factor through the display means to induce energy saving of the region. For example, the energy management unit 270 may display a message such as ‘Recently, an amount of electricity used in a main room increased rapidly. Lowering the lighting of the main room or lower the internal temperature about 1 degree is recommended.’ Then, the resident may check the proposed energy saving solution of the region via the display means, and may select an automatic control as proposed. When the resident requests an automatic control over the energy usage control factor through the home network device installed in the region, the energy management unit 270 may automatically control the operation of the energy apparatus through the home network device based on the energy usage control factor.

Accordingly, the energy management service system 200 of the foregoing structure may manage energy more efficiently by adaptively controlling energy, depending on the situation, in consideration of a change in the surrounding environment such as the absence of residents, weather, seasonal variations, temperature/humidity, and the like.

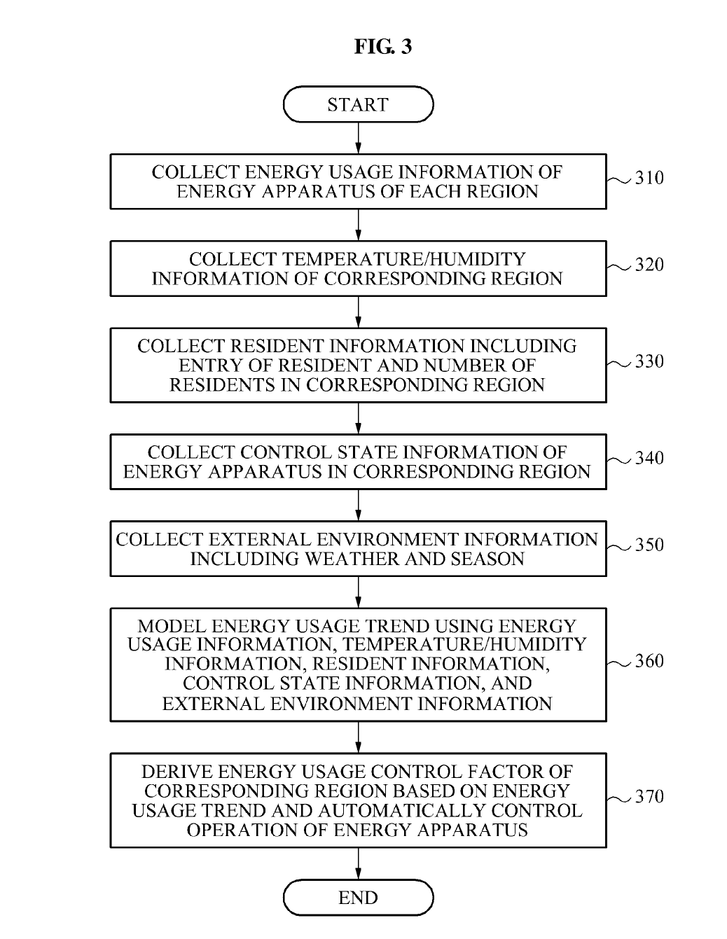

FIG. 3 is a flowchart illustrating an energy management service method for adaptively controlling the use of energy depending on a change in the surrounding environment through energy modeling according to an embodiment of the present invention. The energy management service method according to an embodiment of the present invention may be performed by the energy management service system 200 of FIG. 2, for each operation.

In operation 310, the energy management service system 200 may collect, for each region, energy usage information of a corresponding region including at least one of an amount of electricity used, an amount of gas used, an amount of water used, and an amount of hot water used, through a remote metering server. The energy management service system 200 may collect and organize the energy usage information transmitted from the remote metering server, hourly, diurnally, and monthly.

In operation 320, the energy management service system 200 may collect temperature/humidity information including temperature and humidity of the corresponding region through a temperature sensor and a humidity sensor installed in the region. The energy management service system 200 may monitor the temperature/humidity information of the region with the temperature sensor and the humidity sensor installed in the region, and may organize and store the monitored information in the energy management service system 200 in real time or per predetermined time unit.

In operation 330, the energy management service system 200 may collect resident information including entry of at least one of the residents residing in the region and the number of residents. In this instance, the energy management service system 200 may monitor the entry of people within the region through a motion sensor, a magnetic sensor, and the like, and may collect information about the number of residents and the entry of residents.

In operation 340, the energy management service system 200 may collect control state information of an energy apparatus through a home network device installed in the region to control the operation of the energy apparatus. The home network device that is a controller controlling the operation of an energy apparatus in a region may enable the energy management service system 200 to monitor a power on/off time or an on/off state for each energy apparatus, and the energy management service system 200 may then collect control state information of the energy apparatus in the region from the home network device.

In operation 350, the energy management service system 200 may collect external environment information including weather and seasonal variations of an area corresponding to a region through a linkage to a web server. Here, the web server that is a database system storing and maintaining weather and seasonal variations for each area may provide weather and seasonal variations of the corresponding region in response to a request by the energy management service system 200.

In operation 360, the energy management service system 200 may model an energy usage trend of the corresponding region using the energy usage information, the temperature/humidity information, the resident information, the control state information of the energy apparatus, and the external environment information that have been collected for the region. In this instance, the energy management service system 200 may accumulate the energy usage information and the control state information of the energy apparatus for each predetermined period, may analyze an actual energy usage trend of the corresponding region, and to improve energy efficiency by more than a predetermined percentage relative to the actual energy usage trend, may model an energy usage trend for energy saving based on the temperature/humidity information, the resident information, and the external environment information. Also, the energy management service system 200 may collect the modeled information, and may analyze an energy usage pattern for energy efficiency improvement.

In operation 370, the energy management service system 200 may determine an energy usage control factor based on the information analyzed in operation 360, and may automatically control the energy apparatus in the region based on the determined energy usage control factor. In this instance, at least one of lighting, internal temperature, ventilation, and cutting of standby power may be used as the energy usage control factor. The energy management service system 200 may transmit the energy usage control factor to the home network device of the corresponding region, and the home network device may then generate a control signal for the energy apparatus of the corresponding region based on the energy usage control factor and may control the operation of the energy apparatus based on the generated control signal. Also, the energy management service system 200 may display the energy usage trend and the energy usage control factor on a display means equipped in the home network device of the region through a linkage to the home network device so that at least one resident residing in the region can check the energy usage trend and the energy usage control factor. Then, the resident may check a proposed energy saving solution for the region via the home network device, and may select whether to allow an automatic control as proposed. When the resident requests an automatic control over the energy usage control factor through the home network device, the energy management service system 200 may automatically control the operation of the energy apparatus via the home network device installed in the corresponding region based on the energy usage control factor.

Accordingly, the exemplary embodiments of the present invention may adaptively manage energy depending on the situation by combining energy apparatus usage information and environment information through energy modeling.

As described in the foregoing, the exemplary embodiments of the present invention may collect and organize usage information of an energy apparatus used in an apartment, a house or a building and environment information, and may determine an optimum energy efficiency through energy modeling. Accordingly, the exemplary embodiments of the present invention may efficiently manage energy consumption by automatically controlling each energy apparatus using a value determined to obtain the optimum energy efficiency.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An energy management service system for managing the use of energy for each region, the system comprising:
an energy collecting unit to collect energy usage information for an energy apparatus consuming energy in a region through a remote metering server;
a temperature/humidity collecting unit to collect temperature/humidity information including temperature and humidity of the region through a temperature sensor and a humidity sensor installed in the region;
a resident collecting unit to collect resident information including entry of at least one of residents residing in the region and a number of residents, through at least one sensor of a motion sensor and a magnetic sensor installed in the region;
an apparatus collecting unit to collect control state information of the energy apparatus through a home network device installed in the region to control the operation of the energy apparatus;
an environment collecting unit to collect external environment information including weather and seasonal variations from a web server through a link to the web server;
an energy modeling unit to model an energy usage trend of the region using the energy usage information, the temperature/humidity information, the resident information, the control state information, and the external environment information; and
an energy management unit to determine an energy usage control factor of the region based on the energy usage trend and to automatically control operation of the energy apparatus in the region based on the energy usage control factor.

2. The system of claim 1, wherein the energy modeling unit accumulates the energy usage information and the control state information for each predetermined period, analyzes an actual energy usage trend of the region, and models an energy usage trend exhibiting the improved energy efficiency more than a predetermined percentage relative to the temperature/humidity information, the resident information, and the external environment information.

3. The system of claim 1, wherein the energy management unit determines at least one of lighting, internal temperature, ventilation, and cutting of standby power, as the energy usage control factor.

4. The system of claim 3, wherein the energy management unit transmits the energy usage control factor to the home network device, and
the home network device generates a control signal for the energy apparatus based on the energy usage control factor, and controls operation of the energy apparatus based on the control signal.

5. The system of claim 1, wherein the energy management unit transmits the energy usage trend and the energy usage control factor to a home network device to display the energy usage trend and the energy usage control factor on a display means equipped in the home network device, and when a resident requests an automatic control, via the home network device, the home device automatically controls the energy apparatus based on the energy usage factor.
